(19) United States
(12) Patent Application Publication
(10) Pub. No.: US 2004/0115608 A1
(43) Pub. Date: Jun. 17, 2004

(54) System and method for delivering, receiving and managing continuing educational and training services

(76) Inventors: Paul Meyer, Washington, DC (US); Pamela R. Johnson, Washington, DC (US)

Correspondence Address: Alex Chartove, Morrison & Foerster LLP, Suite 300, 1650 Tysons Boulevard, McLean, VA, 22102, US

(21) Appl. No.: 10/651,202

(22) Filed: Aug. 29, 2003

Related U.S. Application Data
(60) Provisional application No. 60/406,627, filed on Aug. 29, 2002.

(51) Int. Cl. G09B 7/00

(52) U.S. Cl. 434/323

(57) ABSTRACT

The invention relates to a system and method for delivering on-demand educational materials via distributed networks, such as the internet, wireless networks, etc. An end-user may login to the system, request training on a variety of subjects, receive on-demand multimedia training material, provide payment, be tested to ensure that they have understood the training material, and have a notification sent to an employer, government agency, or other entity that has mandated or requested that the end-user has received specified training. The system is particularly useful for ensuring compliance with mandatory training schemes, such as continuing legal education, where private entities may make training available to end-users, while a government entity must track the amount and nature of training received by large groups of individuals.

### TECHNICAL FIELD OF THE INVENTION

The present invention relates to a system and method for collecting, disseminating and managing information from one or more users and systems through a voice transmission, data transmission and data storage network. The information collected, disseminated and managed permits an end user to obtain continuing educational and training content and services via a variety of multimedia sources.

### BACKGROUND OF THE INVENTION

The process of delivering training material, overseeing its use by its intended audience, receiving payment for such material, and recording compliance with various laws, regulations, or private policies regarding the use of training material has traditionally been handled through a series of labor and time-intensive tasks. In the field of delivering continuing legal education, for example, lawyers would be required to attend seminars. People at the seminars would record their attendance and report to various bar associations whether a particular person had attended. The state bar association might then keep a record of each attorney registered to practice in their state to determine whether each of them had completed any annual requirement for continuing legal education imposed on the lawyers of the state.

This process is time-consuming and prone to errors in record keeping. As well, the labor-intensive nature of the process results in high costs incurred by the lawyers for mandatory training. As well, this system does not permit for the electronic delivery of training material in a manner that can verify whether a particular lawyer has viewed and understood the material, nor does it provide for a method by which the lawyers could view the material at their convenience.

In many fields, providing continuing education is, at best, a cumbersome process. For this reasons, it is desirable to have a system that permits on-demand delivery of training materials with automated recordkeeping and billing. As well, it is desirable to have a system that permits for the delivery of training content in multimedia format that is available via a variety of devices and over a variety of distributed networks, such as, for example, telephone and wireless networks, the internet, and even private wide-area networks (WANs).

### SUMMARY OF THE INVENTION

The invention relates to a system and method of delivering on-demand training materials, such as those used for continuing legal education, to an end-user over a distributed network.

The method includes, at least, logging an end-user into the system via a device connected to a distributed network; identifying training material to be delivered to the end-user; querying a vendor for on-demand delivery of the training material; receiving payment for the training material from the end-user; providing the training material to the end-user; validating the end-user's comprehension of the training material; and providing notification to a third-party of the end-user's receipt and comprehension of the training material.

### BRIEF DESCRIPTION OF THE DRAWING FIGURES

FIG. 1 shows an illustrative system diagram of the present invention.

FIG. 2 shows a flow chart illustrating one possible embodiment of the present invention.

FIGS. 2(a)-(2h) show flow charts illustrating the steps of the embodiment shown in FIG. 2 in greater detail.

FIG. 3 illustrates an embodiment of the notification system of the present invention, using the example of continuing legal education.

FIG. 4 illustrates an embodiment of the system log-in and module selection system of the present invention, using the example of continuing legal education.

FIG. 5 illustrates an embodiment of the billing and payment system of the present invention, using the example of continuing legal education.

FIG. 6 illustrates an embodiment of the content transmission system of the present invention, using the example of continuing legal education.

FIG. 7 illustrates an embodiment of the completion and certification system of the present invention, using the example of continuing legal education.

### DETAILED DESCRIPTION OF THE INVENTION

The system and method of the present invention relate to a management service that permits certain authorized end users and administrators to access certain (or all, depending on the particular end user's or administrator's access privileges) components of the system. Such components of the system consist of software or hardware functions that enable end user identification, authentication and authorization, end user account management, archival and real-time sourcing of information and content, content access and transmissions (to and from the system), compliance/non-compliance certification, billing and payment, notifications/customizations, and administration management. An end user may access the system through a “transceiver” device (e.g., a telephone, wireless device, computer connected to a distributed network, etc.) that receives and transmits prerecorded or live audio signals (herein referred to as “Modules”) to the end user, and which has independent capability to transmit data to the system, and may also have capability to transmit audio signals to the system from the end user. A management element controls the manner in which each system component interacts with each other component, and how each end user interacts with the system.

The components of the present invention can be adapted for use by a wide variety of communities in which continuing education or training is required or requested. Such communities include but are not limited to the following: doctors, dentists, optometrists, lawyers, accountants, nurses, members of the armed forces, architects, human resources professionals, engineers, physician assistants, professional coders, respiratory care professionals, environmental services professionals, pharmacists, radiology technicians, case managers, project managers, nursing home administrators, clinical laboratory professionals, Dental Hygienists, Police Officers, Firefighters, Hazardous Materials Handlers, Emergency Medical Technicians, Librarians, Financial Brokers and dealers, Financial Professionals Criminologist, Private Investigators, Social Workers, Insurance Agents, Psychologists, Child Care Professionals, hair dressers, airline pilots, truck drivers, transportation professionals, customs inspectors, security guards, government employees and employees in a corporation. The components of the present invention can also be adapted for access and use via any transceiver device, including but not limited to a wireline telephone, a wireless telephone, a personal digital assistant, a digital audio radio, a computer or any other Internet or network-connected device. The components of the present invention can also be adapted for access and use by end users through various transceiver devices while the end users are in airplanes.

One key aspect of the system is the capacity to keep track of information related to an end user's usage of the system. The system can keep track of when each end user logs on and how long they are logged on. The system can keep track of which modules end users access, whether they listen to the entire module, and can track other attributes about those modules, such as the price of the module or how much credit is associated with the module. The system can also keep track of the end user's responses to any questions asked as part of or in conjunction with the module.

The system can be organized in a number of different architectures, including but not limited to: (i) a model in which the system components are deployed and managed by the system administrator at its own site(s), or another site(s) of its choice, (ii) an application services provider (ASP) model in which a third-party(-ies) deploys and hosts the system components on behalf of the system administrator; or (iii) a “hybrid” model in which certain components of the system are hosted by a third-party (-ies) and certain components are hosted by the system administrator.

The system is designed such that it can be offered to end users as a stand alone service whereby end users can order and pay for specific modules or a series of modules. Alternatively, the system can be deployed in conjunction with other educational offerings, including but not limited to live offerings, Internet-based offerings, CD or audiotape-based offerings, DVD, CD-ROM or VHS-based offerings, conference call-based offerings, or any courses or offerings that combine these or other media.

In an illustrative embodiment, the present invention would permit a lawyer to satisfy a California State Bar Association continuing legal education (CLE) requirement through use of the system. In sum, the lawyer would: (i) make a telephone call to the system, (ii) sign-in, (iii) pay for, (iv) request and listen to an on-demand presentation of a sixty minute mandatory course on “Tort Reform”, or any other subject, via his telephone. The system would in turn notify the State Bar Association and/or her law firm that she had successfully listened to and completed her mandatory course requirement on Tort Reform.

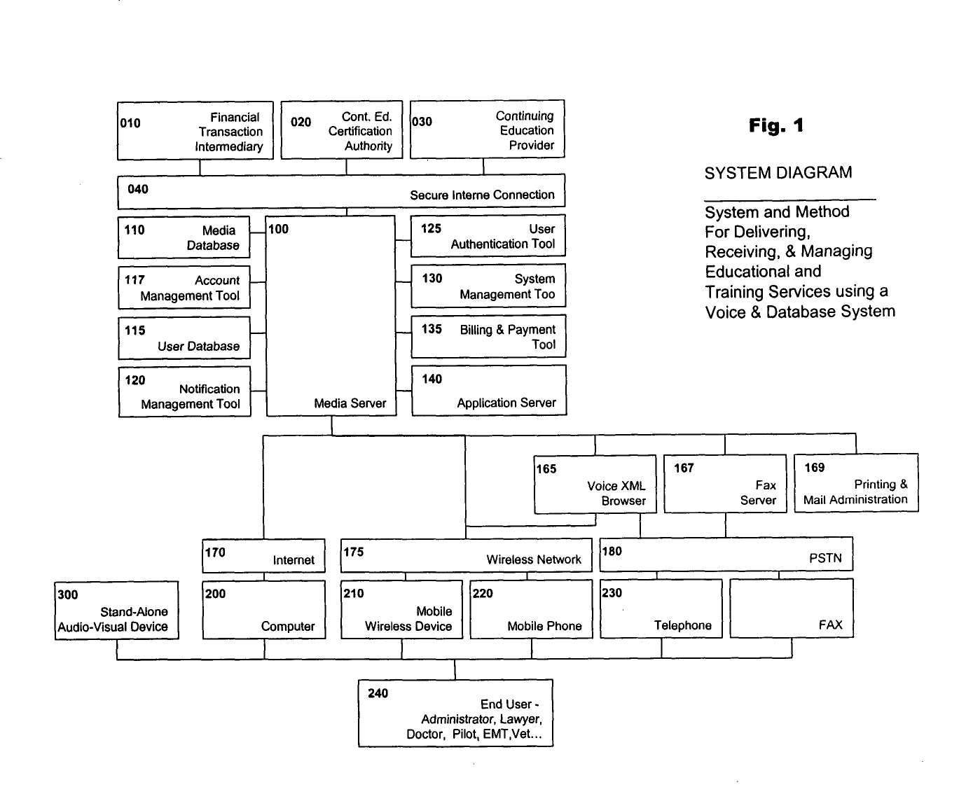

An overview of an exemplary embodiment of structure of the present invention is shown in FIG. 1. In further detail, the end-user 240, as shown in FIG. 1, may login to the system via a variety of devices, such as computer 200 that connects to the media server 100 through the internet 170. Alternatively, the end-user 240 may connect to a stand-alone content delivery device 300 to view training materials, or the end-user 240 may use a mobile wireless device 210 or wireless telephone 220 to connect to the media server 100 through a wireless network 100. Additional alternative methods of connecting the end-user 240 with the content available via the media server 100 are shown as well.

The media server 100 is in electronic communication with various modules, such as the user authentication tool 125. Although those skilled in the art will readily identify various protocols to be used in the electronic communication between the media server 100 and the various modules connected thereto, a preferred embodiment of the invention employs the lightweight directory access protocol (LDAP) for user authentication. Databases are accessed using typical protocols, such as SQL and the application server may use a variety of protocols, such as http, WAP (wireless access protocol), SMTP, etc. Rendering may use HTML, WML (wireless markup language), SMS, VoiceXML, etc.

The media server 100 is also in communication with a financial transaction intermediary 010, if end-users are to be billed for content-delivery or other features of the system, a continuing education certification authority 020, and a continuing education provider 030. Other services may be connected to the media server 100, if desired. Generally, services such as these will connect to the media server 100 via a secure protocol such as shttp and may employ secure socket layers (SSL). The continuing education certification provider may use the X.509 protocol, for a PKI certificate.

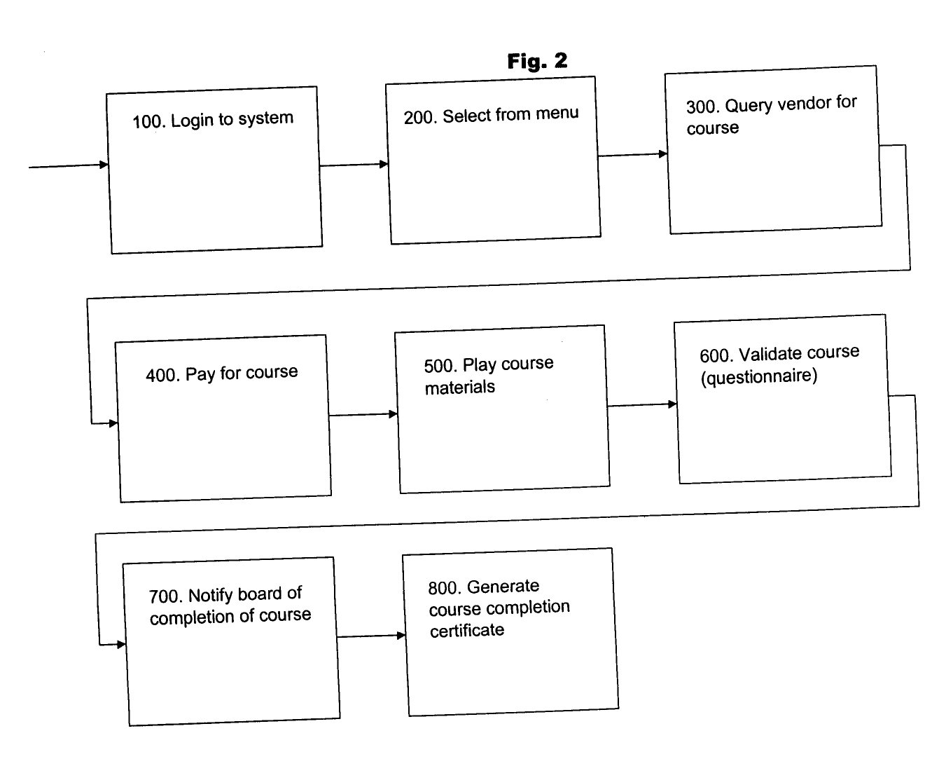

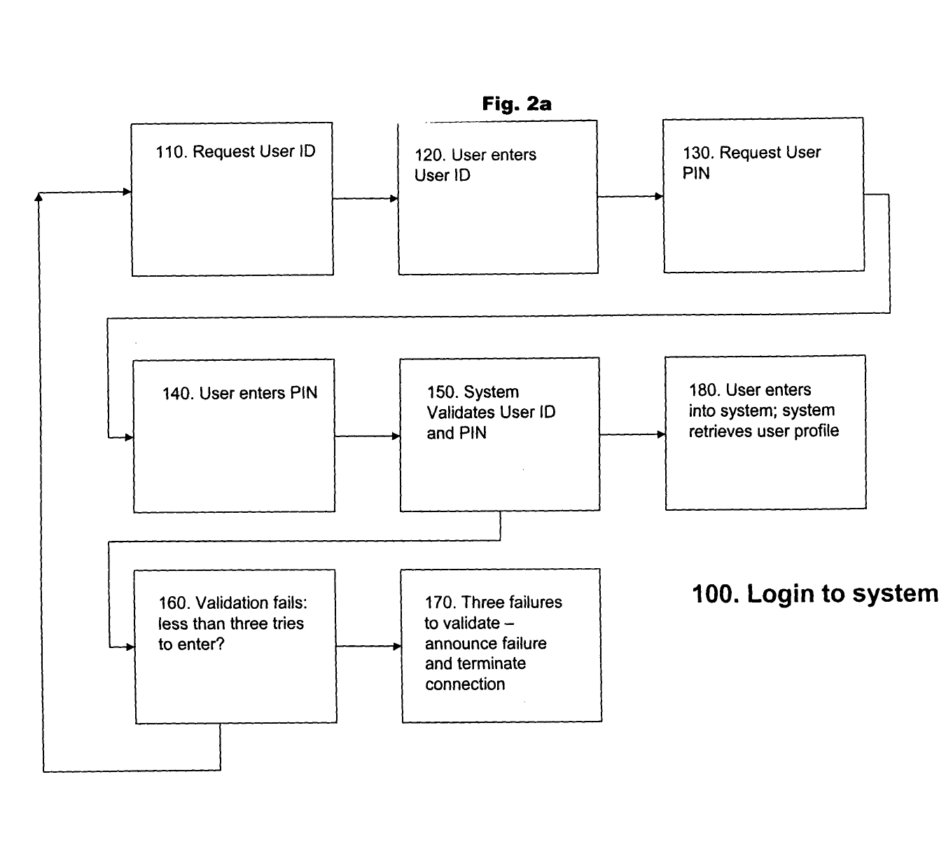

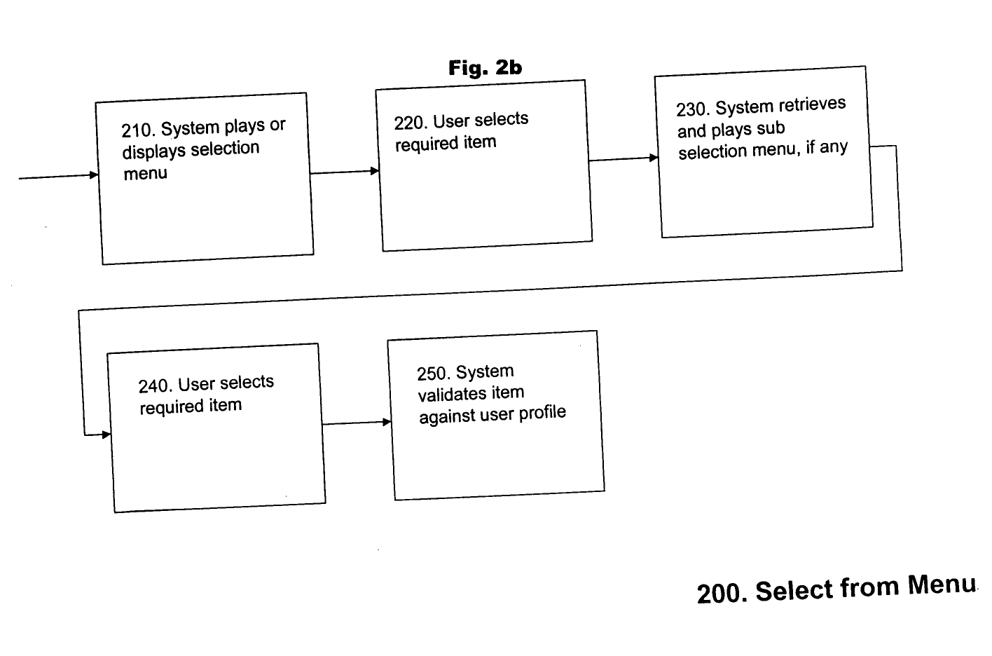

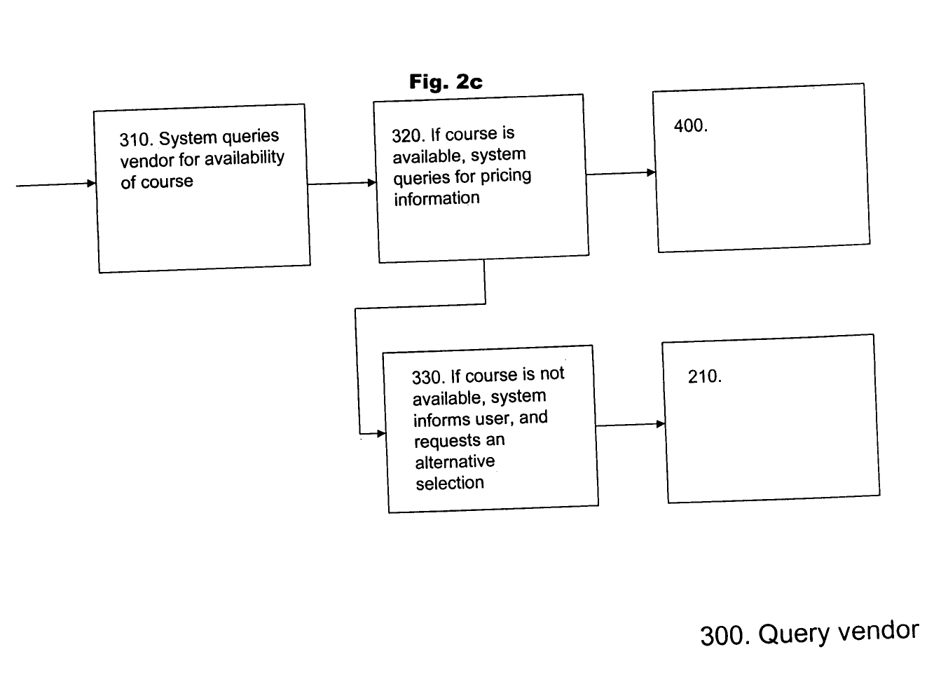

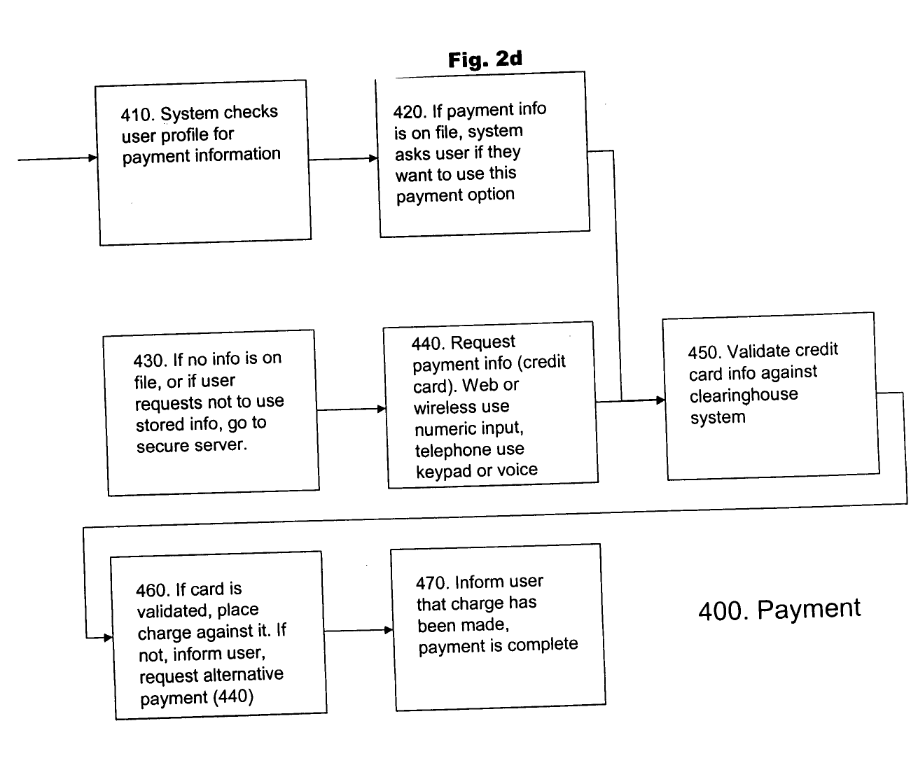

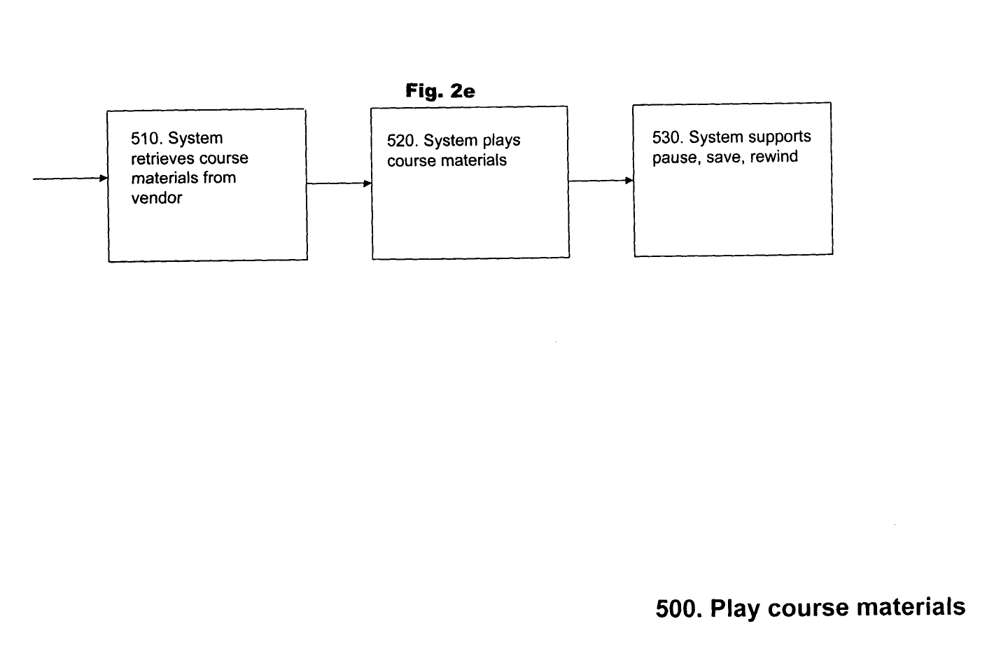

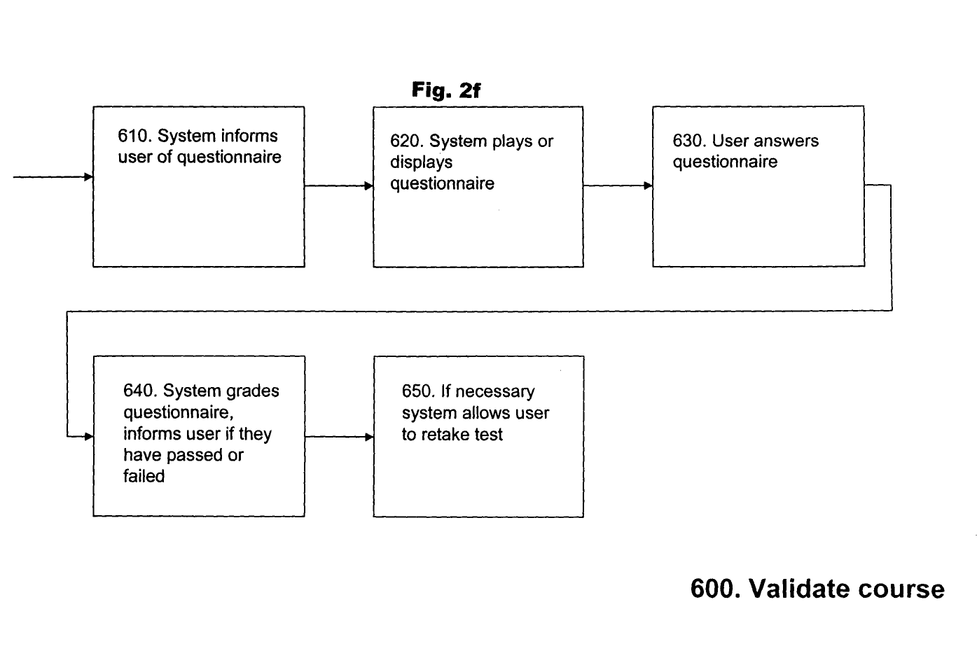

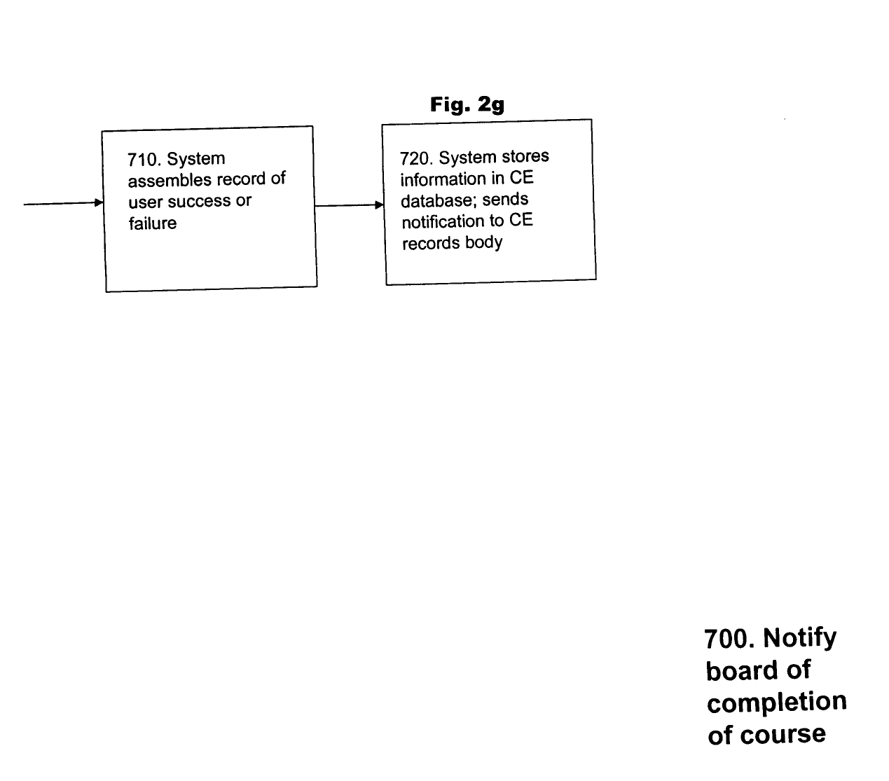

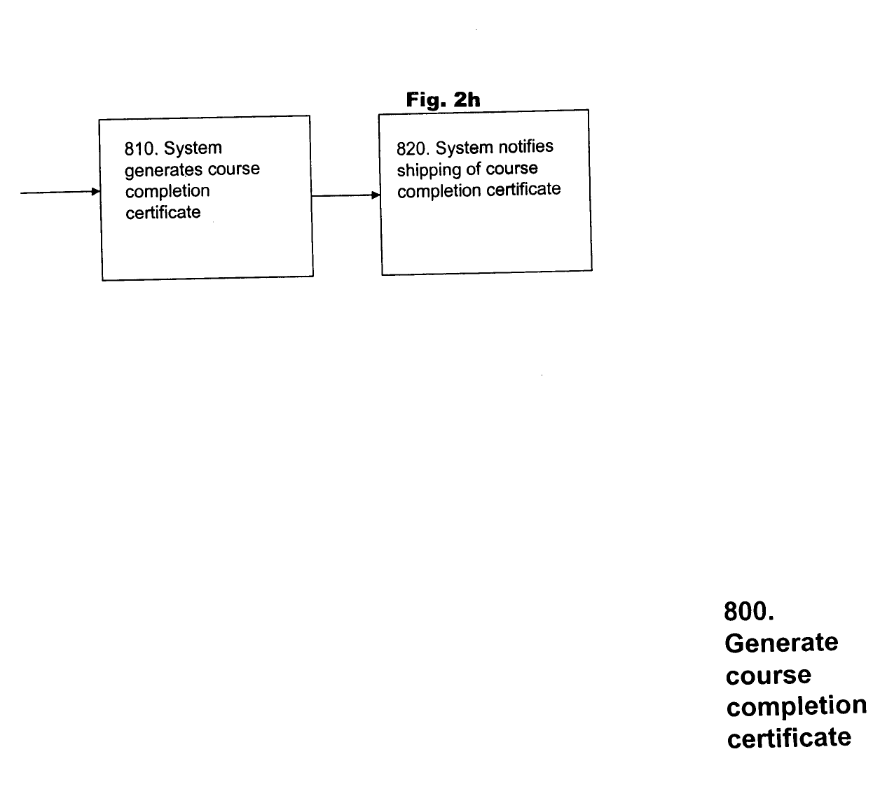

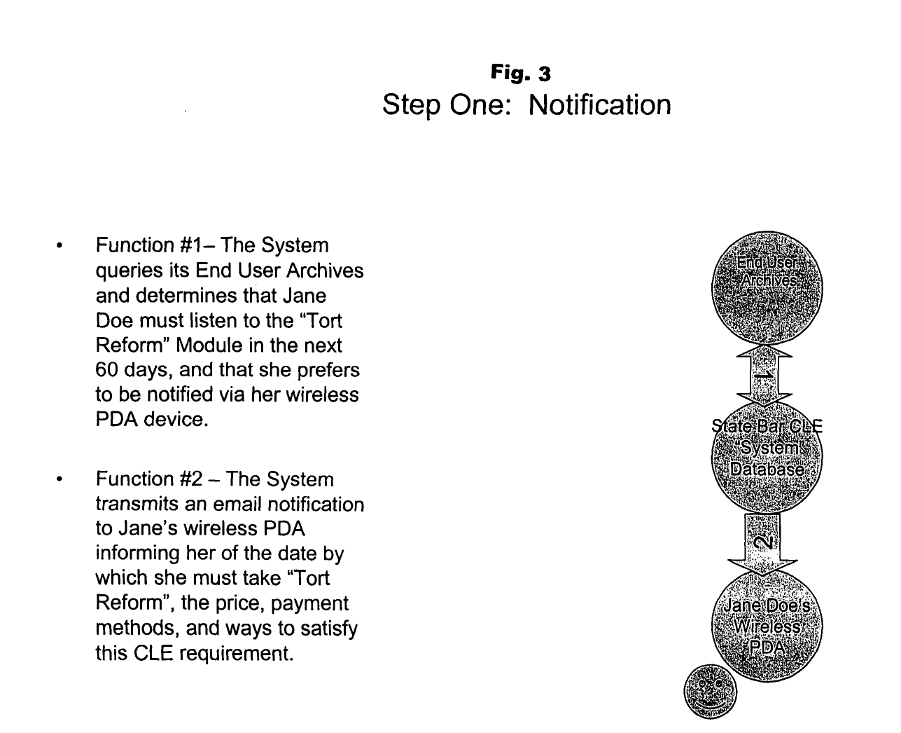

FIG. 2 illustrates a flow chart overview of an illustrative embodiment of the present invention. FIGS. 2(a)-(h) provide detailed, illustrative flow diagrams of the steps shown in FIG. 2.

The present invention may also permit the lawyer to manage her own personal continuing legal education account, and to receive notices for upcoming courses that satisfy her continuing obligations via her telephone or any other transceiver device. A corollary to this functionality is that the system administrator—in this example, the California State Bar Association—would use the system to securely manage its course content, track end user billing and usage, and certify compliance by the lawyer to the lawyer (in writing, via email, or other notification method) and to any other applicable entities. More specifically, the process may occur as follows.

Step 1, as shown in figure three, may comprise notification. The California State Bar performs a daily query of its end user records database and determines that Jane Doe, a lawyer and member of the California State Bar Association, must take a one-hour course on “Tort Reform” in the next sixty days to satisfy her ongoing CLE requirements. The system reviews her end user account and determines that she prefers to receive notifications on her wireless PDA in the form of emails. The system sends her a customized email notification informing her of the course requirement, its cost, and the various methods in which she can satisfy the course requirement—one of which is to call the system and listen to the Tort Reform Module.

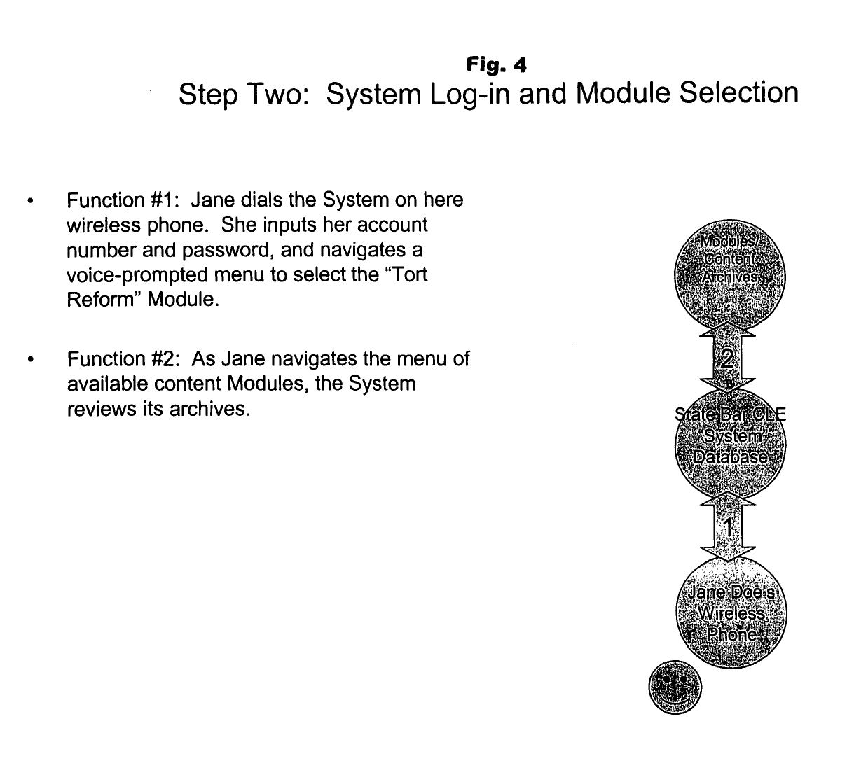

Step 2, as illustrated in FIG. 4, may comprise system Log-in and module selection. Jane Doe receives the notification on her wireless PDA, and decides that she will call the system and listen to the Module while sitting on her train ride from Washington D.C. to New York city. She calls the system on her wireless telephone. The system asks for her account number, her password, and identifies and authenticates these against her account profile. Once authorized to access the system, Jane navigates through a voice-prompted menu and selects the “Tort Reform” Module.

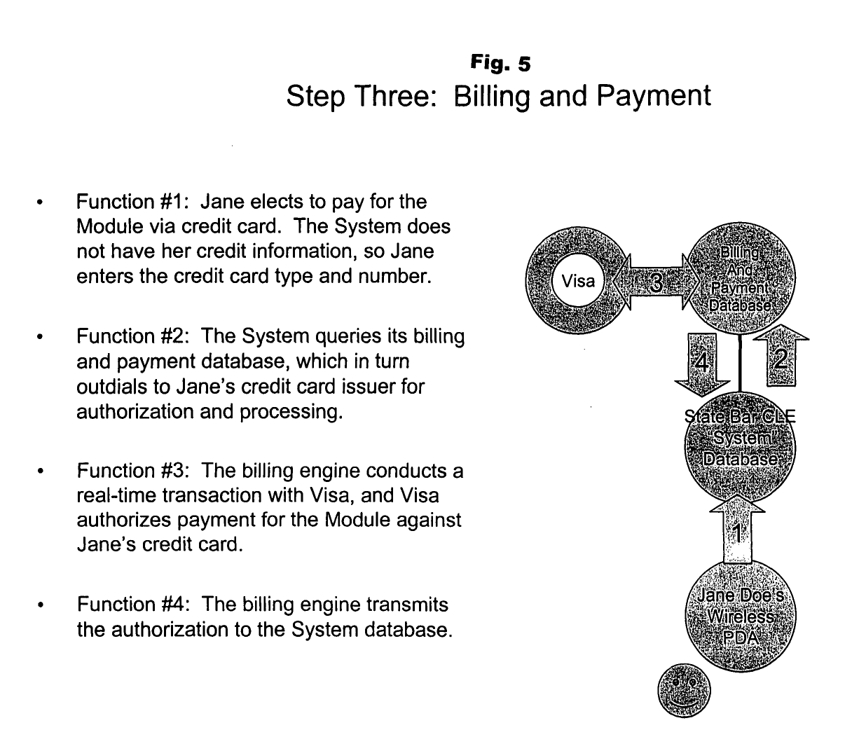

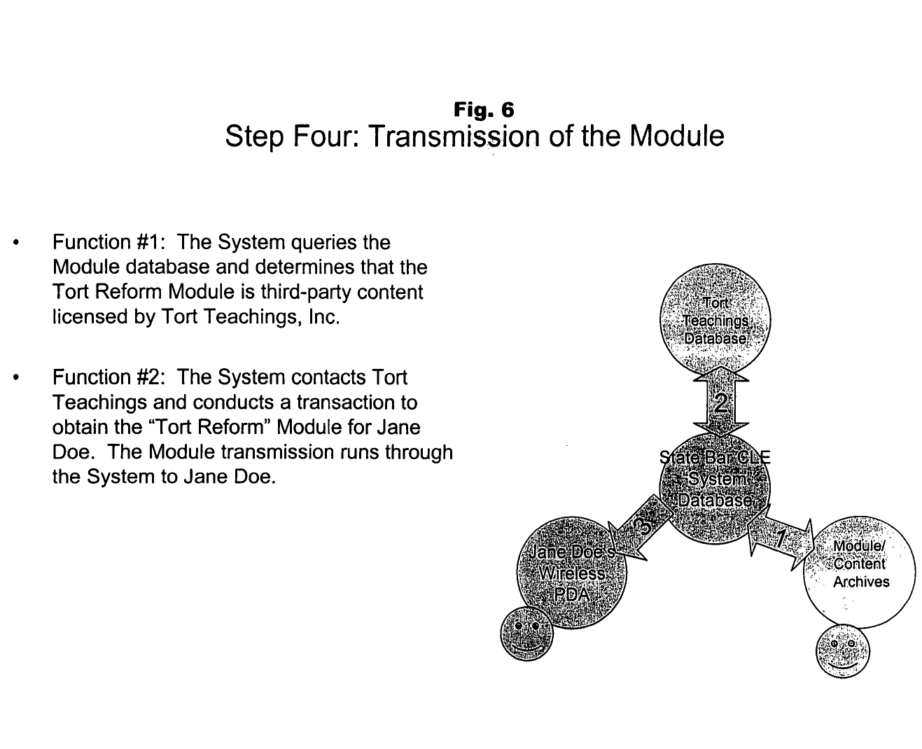

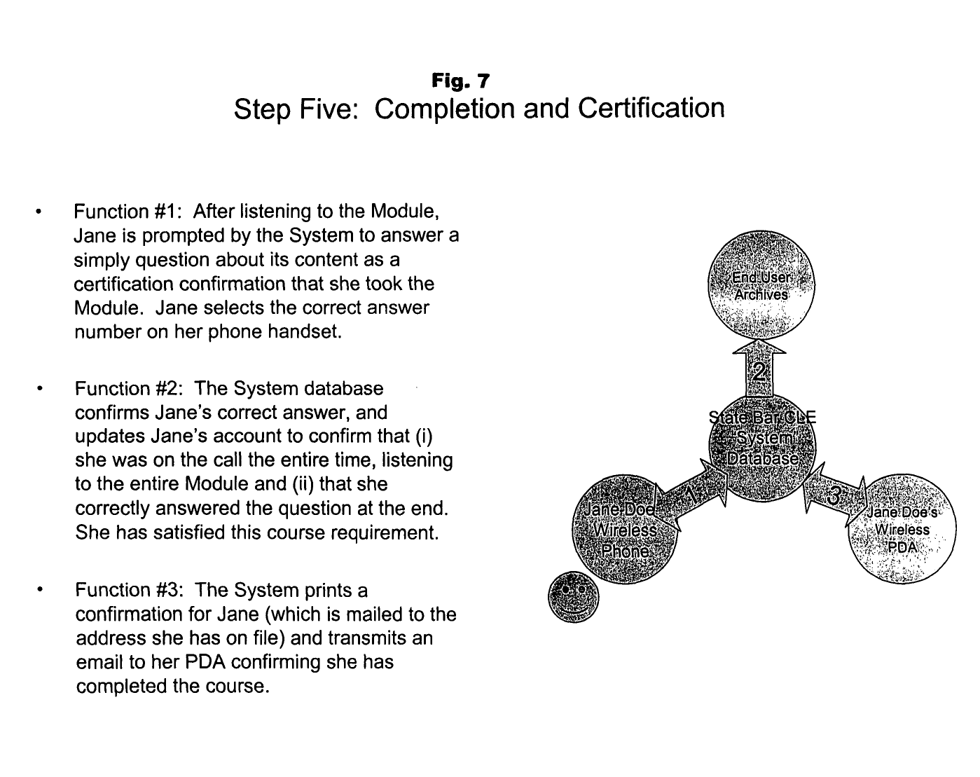

Step 3, as illustrated in FIG. 5, may comprise billing and payment. When prompted by the system, Jane elects to pay for the Module by credit card. The system does not have her credit card information in its archives, so Jane enters her information by voice as prompted. The system then outdials and completes the transaction in real-time with her credit card issuer.

Step 4, as illustrated in FIG. 6, may comprise transmission of the module. The “Tort Reform” Module is not owned by the State Bar Association, but rather is licensed from an independent third-party company called Tort Teachings, Inc. The system queries the Tort Teachings content database and “sources” or orders, according to the terms of a prior contractual arrangement between the State Bar and Tort Teachings, a license to transmit on a real-time basis the “Tort Reform” Module to a single end user. Tort Teachings then streams on a real-time basis that Module throughout the system to Jane Doe. Jane listens via her wireless phone's “earbud” microphone, pausing and rewinding the Module intermittently via the controls on her phone keypad as necessary so that she can accurately take notes.

Step 5, as illustrated in FIG. 5, may comprise completion and certification. After listening to the entire Module, the transmission ends. This particular CLE requirement is not a good faith “self-certification” requirement, so the system prompts Jane to answer a simple question concerning the content of the “Tort Reform” Module. Jane is presented with four possible answers, and selects the correct answer. The system informs Jane of her correct selection, and updates her end user account to reflect her successful completion of the Tort Reform Module within the sixty-day window, based upon her listening to the entire transmission and her successful answer to the question at the end of the transmission. The system simultaneously prints a certification notice and invoice to reflect Jane's purchase and completion of the Module, along with a duplicate copy for the State Bar Associations files. Jane's copy is mailed to her for her records. The system also sends an email to Jane's wireless PDA to inform her of her successful completion and any upcoming course requirements.

In a slightly more advanced embodiment, the present invention would permit a company's CEO to call in to the system, log-in to the system and to record a message—or, Module—to his employees via his wireless telephone. The system would record and archive the audio file and notify the employee end users of the existence of the Module and the requirement that they listen to the Module by a certain date and time. The system would then permit employees to use any transceiver device to listen to the Module. The system would track and analyze usage and compliance, and would report compliance to the CEO.

The system components would, in such an embodiment, include the following:

Authentication—An end user would access the system via a transceiver and identify herself as prompted by the system, via any number of personally unique identifiers including but not limited to a unique sequence of numbers, letters, of a combination thereof, voice recognition technologies, automatic number identification (ANI) of the calling transceiver, any biometric device or method, or any other manner of discriminating among and securely identifying, authenticating and authorizing discrete end users.

Account management—An end user could manage his account via a visual or audio menu that could be accessed by any number of different communications devices including a transceiver, an electronic device using a graphical user interface (GUI), or other method of visual or audio review and selection. The account management component would maintain archives of all end user educational or training requirements, options, course completions and credits, billing information, account preferences and other personally identifiable information.

Archival and Real-time Sourcing—The system administrator will be able to employ the system to source Modules on a real-time basis from third-parties for on-demand use, or to archive copyrighted or otherwise owned or licensed Modules for use at a later time.

Module access and transmissions—Once authenticated, the system would permit the end user to access and listen to individual Modules, as well as select from a number of control and management options including but not limited to rewind, pause, forward, hold, fax/email/transmit on demand, resume from a previous point in a prior call, and transmit to the system archives.

Certification—Once an end user successfully completes a Module, the system would communicate that fact to the system administrator or a predetermined designee of the system administrator. The system would also provide the administrator with the option to verify that the end user actually listened to, and understood, the Module by querying the end user concerning its contents and requiring an accurate response(s) prior to certification.

Billing and Payment—The system will access real-time all billing information and conclude all necessary payment transactions, including credit card charges or applications of credits, necessary to permit an end user to purchase or access a Module.

Notifications/Customization—The system will monitor the compliance requirements of individual end users, and transmit custom notices end users that include such information, along with other relevant information such as Module availability/descriptions, credits and pricing, and other marketing information. The system will also analyze usage patterns, preferences, and other information about the end user that will enable the system to create personalized content Modules for the end user based upon any number of factors such as stated preferences, or system usage history and patterns.

Administration management—The system would permit the system administrator (e.g., the regulatory agency, association, company or other body that owns/controls the Modules and/or establishes or monitors the ongoing education or training requirements) to control the manner in which each system component interacts with each other component, and how each end user interacts with the system, via a GUI or via any other method of visual or audio review and selection. The administration management component would also permit the system administrator to synthesize and analyze all information generated and tracked by the system, including but not limited to usage, Module number and characteristics, and aggregated and disaggregated end user information.

What is claimed is:

1. A method comprising:
logging in an end-user via a device in communication with a distributed network,
identifying educational material to be delivered to the end-user,
querying a vendor for on-demand delivery of the educational material,
receiving payment from the end-user for the educational material,
delivering the educational material to the end-user,
validating comprehension of the educational material by the end-user, and
providing notification to a third-party of the delivery of the educational material to the end-user and the comprehension of the educational material by the end-user.

2. The method of claim 1 wherein the training material comprises subject matter selected from the group consisting of legal, medical, dental, optometry, accounting, nursing, military, architectures, human resources, general corporate, engineering, physician assistance, professional coding, respiratory care, environmental services, pharmacological, radiology, case management, project management, nursing home administration, clinical laboratory, dental Hygiene, law enforcement, firefighting, hazardous materials handlers, emergency medicine, librarial, financial brokerage and dealing, general finance, criminology, private investigation, social work, insurance sales, insurance claims processing, insurance regulatory compliance, general regulatory compliance, agency, psychology, child care, hair dressing, piloting, commercial trucking, transportation, inspection, private security, government employment, and variations and combinations thereof.

3. The method of claim 1 wherein the device is a computer.

4. The method of claim 1 wherein the device is a wireless device.

5. The method of claim 1 wherein the device is a telephone.

6. The method of claim 1 wherein the distributed network is the internet.

7. The method of claim 1 comprising issuing a certificate to indicate that the end-user as reviewed and understood the training material.

8. The method of claim 1 wherein the training material is delivered to the end-user in a computer readable multimedia format.

9. The method of claim 1 wherein the training material is delivered to the end-user in a streaming multimedia format.

10. The method of claim 1 wherein the training material comprises audio.

11. The method of claim 1 wherein the training material comprises audio and video.

12. The method of claim 1 wherein the training material comprises video.

13. The method of claim 1 wherein the training material comprises interactive multimedia.

14. The method of claim 1 comprising storing the educations status and/or educational history of the end-user.

15. The method of claim 14 comprising sending a notification to the end-user to indicate that training must be performed.

16. A method comprising:
storing the educational history of an end-user in a database,
querying the database to identify an end-user that must perform training,
sending a notification to the end-user to indicate that training must be performed,
logging in the end-user via a device in communication with a distributed network,
identifying educational material to be delivered to the end-user,
querying a vendor for on-demand delivery of the educational material,
receiving payment from the end-user for the educational material,
delivering the educational material to the end-user,
validating comprehension of the educational material by the end-user, and
providing notification to a third-party of the delivery of the educational material to the end-user and the comprehension of the educational material by the end-user.
